(19) United States
(12) Patent Application Publication
(10) Pub. No.: US 2010/0260011 A1
(43) Pub. Date: Oct. 14, 2010

(54) CADENCE ANALYSIS OF TEMPORAL GAIT PATTERNS FOR SEISMIC DISCRIMINATION

(75) Inventors: Theodore W. Berger, Rancho Palos Verdes, CA (US); Alireza Dibazar, Los Angeles, CA (US); Hyung O. Park, Torrance, CA (US)

Correspondence Address: MCDERMOTT WILL & EMERY LLP, 2049 CENTURY PARK EAST, 38th Floor, LOS ANGELES, CA, 90067-3208, US

(73) Assignee: UNIVERSITY OF SOUTHERN CALIFORNIA, Los Angeles, CA (US)

(21) Appl. No.: 12/756,657

(22) Filed: Apr. 8, 2010

Related U.S. Application Data
(60) Provisional application No. 61/167,822, filed on Apr. 8, 2009.

(51) Int. Cl. G01V 1/30

(52) U.S. Cl. 367/38

(57) ABSTRACT

Systems, methods, and apparatus are described that provide for analysis of seismic data. Features of temporal gait patterns can be extracted from seismic/vibration data. A mean temporal gait pattern can be determined. A statistical classifier can be used to model features of the data. The model can be used to classify the data. As a result, discrimination of seismic sources can be performed. Systems for discrimination of seismic data are also described. A system can include a vibration sensor system configured and arranged to detect vibrations. A system can also include a processor system configured and arranged to receive data from the vibration sensor, recognize the seismic data as belonging to a particular class of seismic data, and produce an output signal corresponding to the recognized particular class of seismic data.

### CROSS-REFERENCE TO RELATED APPLICATIONS

This application is based upon and claims priority to the following: U.S. Provisional Patent Application No. 61/167,822 entitled “CADENCE ANALYSIS OF TEMPORAL GAIT PATTERNS FOR SEISMIC DISCRIMINATION BETWEEN HUMAN AND QUADRUPED FOOTSTEPS,” filed Apr. 8, 2009, attorney docket 028080-0457 (USC 09-225); the entire content of which is incorporated herein by reference.

### STATEMENT REGARDING FEDERALLY SPONSORED RESEARCH

This invention was made with Government support under Contract No. N00014-06-1-0117 and Contract No. SD121905 awarded by the Office of Naval Research (ONR). The Government has certain rights in the invention.

### BACKGROUND

1. Technical Field

This disclosure relates to signal analysis of seismic signals.

2. Description of Related Art

With the growing interest on security problems, the development of technologies that can detect potential threats such as a human or vehicle approaching military assets has been stimulated. One area of interest is to utilize seismic waves propagating from the source i.e. a threat in order to recognize the threat. Seismic sensors are small enough that they can be easily hidden away so as to not be noticeable from an intruder's visual inspection. Moreover, the creation of artificial vibrations intended to cause confusion in the recognition process is very difficult.

Previous works in the domain of seismic detection of human vs. quadruped have relied on the fundamental gait frequency. Slow movement of quadrupeds can generate the same fundamental gait frequency as human footsteps therefore causing the recognizer to be confused when quadruped are ambling around the sensor.

The signal measured from a geophone typically has a 0.1 Hz˜100 Hz frequency range, due to the resonant characteristics of the sensors. Although the frequency response of the seismic sensor is in a relatively narrow frequency band, spectral analysis can be used for discriminating between seismic events caused by human footsteps or four-legged animals (quadrupeds) and/or vehicles. Due to the very similar walking mechanism of humans and animals, however, the generated rhythmic temporal seismic patterns of humans and animals are very similar. This renders the discrimination between a human's and an animal's footstep using frequency analysis as inadequate in many situations.

### SUMMARY

Aspects of the present disclosure address limitations noted previously and are directed to techniques, including systems, methods, and apparatus, providing for the ability to recognize and classify acoustic signals, e.g., seismic signals, by processing data for determination of temporal gait patterns.

An aspect of the present disclosure is directed to methods of seismic analysis that can utilize a temporal gait pattern as a discriminating factor, e.g., to tell the difference between bipedal and quadruped footsteps.

An exemplary embodiment includes a method of seismic discrimination for detecting human footsteps. The method can include, with a computer system, determining a gait period from a temporal window of seismic data. With the computer system, the temporal window can be partitioned into k number of smaller sub-windows, each having a length equal to the gait period. With the computer system, the signals can be averaged within the sub-windows. With the computer system, a shift-invariant temporal gait pattern can be determined from the averaged signals of the sub-windows. With the computer system, a number of weighting functions can be applied to the temporal gait pattern, producing a like number of features of the temporal gait pattern. With the computer system, the features can be modeled with a statistical classifier. With the computer system, the seismic data can be recognized (or, classified) as belonging to a particular class of data, e.g., biped or quadruped.

The features can be modeled with a statistical classifier using a Gaussian Mixture Model (GMM).

Determining the gait period can include using the auto-correlation function.

Determining the shift-invariant temporal gait pattern can include circular-shifting the temporal gait pattern.

Applying a number of weighting functions to the temporal gait pattern can include applying twelve weighting functions.

The weighting functions can be triangular.

Using a Gaussian Mixture Model can include training a model parameter.

Training the model parameter can include using the Figueiredo-Jain algorithm.

With the computer system, additional (e.g., subsequent to the training) seismic data can be recognized as belonging to a particular class of data.

The particular class of data (from one or more classed) can include seismic data corresponding to human footsteps.

The particular class of data can include seismic data corresponding to quadruped footsteps.

The particular class of data can include seismic data corresponding to one or more vehicles.

Such vehicles can be heavy track vehicles.

Gait frequency can be used for further recognition of seismic data.

The temporal window can be moved across the seismic data.

Moving the temporal window can include moving the temporal window across the seismic data with a desired degree of overlap.

The window can be three seconds wide and the overlap can be about two seconds.

The method can include enhancing signal-to-noise ratio of the seismic data by passing the data through a band-pass filter.

The method can include using a Hilbert transform and low-pass filter to extract an envelope of a seismic signal.

The method can include applying a threshold to the auto-correlation function.

The threshold can be at a window corresponding to about 0.5 Hz to about 7 Hz.

Another aspect of the present disclosure is directed to systems providing seismic analysis utilizing a temporal gait pattern as a discriminating factor, e.g., to tell the difference between biped and quadruped footsteps.

An exemplary embodiment of a system for discrimination of seismic data can include a vibration sensor system configured and arranged to detect vibrations. The system can also include a processor system configured and arranged to (i) receive data from the vibration sensor, (ii) recognize the seismic data as belonging to a particular class of seismic data, and (iii) produce an output signal corresponding to the recognized particular class of seismic data.

The processor system can further be configured and arranged to: (iii) determine a gait period from a temporal window of the seismic data, (iv) partition the temporal window into k number of smaller sub-windows, each having a length equal to the gait period, (v) average the signals within the sub-windows, (vi) determine a shift-invariant temporal gait pattern from the averaged signals of the sub-windows, (vii) apply a number of weighting functions to the temporal gait pattern and produce a like number of features of the temporal gait pattern, and (viii) model the features with a statistical classifier.

The system can further include a wireless transmitter for transmitting the output signal corresponding to the recognized class of seismic data.

The vibration sensor system can include one or more geophones, or other suitable vibration sensors.

The particular class of data can include seismic data corresponding to human footsteps.

The particular class of data can include seismic data corresponding to quadruped footsteps.

The particular class of data can include seismic data corresponding to or more vehicles.

The vehicles can be heavy track vehicles.

The processor system can further be configured and arranged to use gait frequency for recognition of seismic data.

These, as well as other components, steps, features, benefits, and advantages, will now become clear from a review of the following detailed description of illustrative embodiments, the accompanying drawings, and the claims. Other embodiments can be practiced within the scope of the present disclosure.

### BRIEF DESCRIPTION OF DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1A depicts a box diagram of a method for cadence analysis of temporal gait patterns, in accordance with exemplary embodiments of the present disclosure;

FIG. 1B depicts a box diagram of a system for cadence analysis of temporal gait patterns, in accordance with exemplary embodiments of the present disclosure;

FIG. 2 includes FIGS. 2A-2B, which depict plots of vectors for horse and human classes, in accordance with exemplary embodiments of the present disclosure;

FIG. 3 depicts four plots showing seismic data from a horse's footsteps and their recognition, in accordance with exemplary embodiments of the present disclosure; and

FIG. 4 depicts two plots illustrating temporal signals of human footsteps and their recognition by an embodiment of the present disclosure, in accordance with exemplary embodiments of the present disclosure.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

Aspects of the present disclosure are directed to seismic cadence analysis providing discrimination between human footsteps and other seismic/vibration signals.

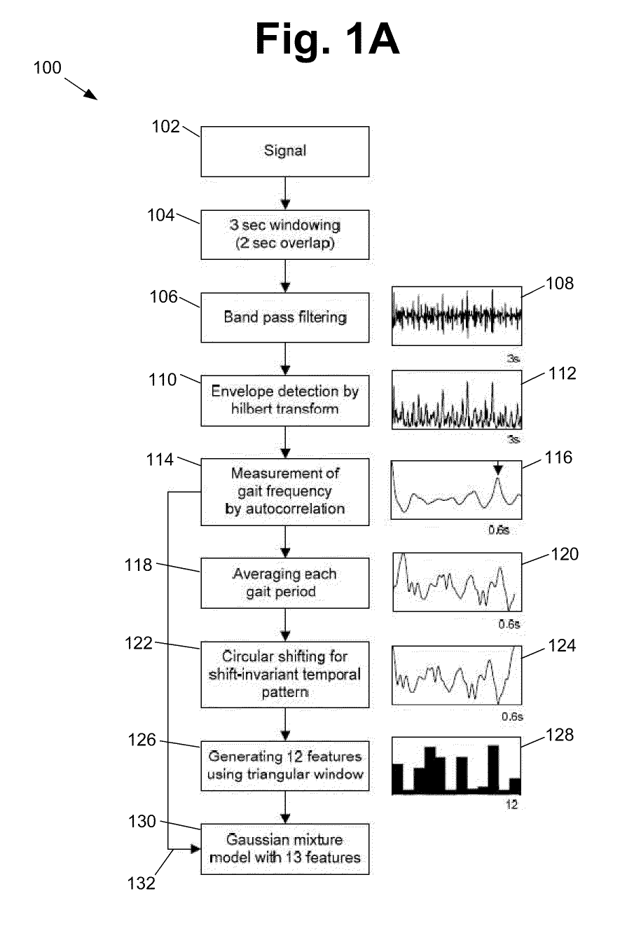

FIG. 1A depicts a box diagram of a method 100 for cadence analysis of temporal gait patterns, in accordance with exemplary embodiments of the present disclosure. Method 100 can, of course, be implemented as suitable computer-readable instructions in a computer-readable medium (flash, RAM, ROM, etc.) and/or by corresponding signals, e.g., suitable for transmission over a communications network (LAN, WAN, Internet, wireless IR or RF, etc.). General portions/steps of method 100 include extracting features from seismic/vibration data, determining a mean temporal gait pattern, and then use of a statistical classifier to model features of the data for classification/recognition of signals within the data.

For method 100, data from seismic or acoustic/vibration sensors, indicated by signal 102, can be received or collected. A sliding window can be applied with a desired amount of temporal overlap, e.g., two seconds, on the incoming signal, as described at 104. The signal can then be passed through a band-pass filter to enhance the Signal to Noise Ratio (SNR), as described at 106, with corresponding representative signal waveforms shown at 108. Envelope detection can then take place to extract the envelope of the seismic signal(s), e.g., by application of a Hilbert transform and low pass filtering (smoothing process), as described at 110. Corresponding representative signal waveforms are shown at 112.

Next, the signal can be utilized to extract the mean temporal pattern of the gait by averaging over each gait period. It can, therefore, be desirable to estimate the gait period within the temporal window and partition the signal (e.g., within the three seconds) based on gait period.

For exemplary embodiments, this can be achieved by estimating a gait period (or frequency) by using the auto-correlation function, e.g., as described at 114. A corresponding representative signal waveform is shown at 116. Because of the periodicity in the signal(s), the auto-correlation signal can have a local maxima at the time of gait period. In general, finding the local maxima may be challenging, however, due to the resonant characteristics of the seismic sensors and the periodicity from walking mechanism, there is a detectable peak (arrow) in the auto-correlation function. The gait period (which can provide cadence frequency) can later be employed as one the features for modeling purposes.

Using the estimated gait period, the temporal window can be equally divided into k number smaller windows each having gait period length. The partitioned signals can then be averaged, as described at 118. A corresponding representative signal waveform is shown at 120.

In order to facilitate a shift-invariant temporal gait pattern representation, the averaged gait pattern from 118 can be circular-shifted so that the local maxima of the pattern is on the first sample, e.g., as described at 122. A corresponding representative signal waveform is shown at 124. The partitioning of the temporal window signal (e.g., three second signal) into k frames can have some remainder, which can be considered/accommodated in the circular shift of the next consecutive frame.

Lastly, a number of suitable weighting functions, e.g., twelve (12) triangular weighting functions, can be applied to the sub-windows, as described at 126. A corresponding representative signal waveform is shown at 128. As a result, the gait temporal pattern can be represented by a number of features, e.g., twelve (12) features. The features can then be modeled by a suitable classifier, e.g., a Gaussian Mixture Model, which can employ training as a feature, as described at 130. The gate period derived from the autocorrelation, can be used as a feature for modeling, as described at 132.

FIG. 1B depicts a box diagram of a system 150 for cadence analysis of temporal gait patterns, in accordance with exemplary embodiments of the present disclosure. System 150 can include a processor or processor system 152 that can function to perform one or more or all of the portions/steps of method 100 of FIG. 1A. For example, process 152 can be a suitably programmed CPU performing operations according to computer-readable instructions as stored in memory (e.g., flash, ROM, RAM, etc.) or received from an outside source. System 150 can also include a seismic/vibration sub-system or sensor 154. Sensor 154 operates to receive seismic/sound data from the environment (local to the sensor) and relay corresponding signals to the processor 152. Sensor 154 can be a suitable geophone, microphone, or the like. An example of a suitable geophone is the SM-24XL geophone made commercially available by Ion Geophysical Corporation of 12300 Parc Crest Drive, Stafford, Tex. 77477. System 150 can also include a communications system 156, e.g., a transceiver (two-way communication) or transmitter (one-way communication). System components 152, 154, 156, can be configured together, e.g., within a single housing or on a shared platform 158, or can be located at different locations, e.g., connected by wire or wireless communications links 160. As shown, system 150 can include a power source 162, e.g., battery or other power supply, that supplies one or more of the system components with suitable power. Exemplary embodiments of system 150 can utilize a suitable solar power system, with photovoltaic cells, as a power source 162.

In operation, system 150 can function to receive seismic data from the environment by way of the sensor 154. The processor 152 can classify, or recognize, signals within the sensed data as belonging to a particular class, e.g., having a bipedal or quadruped origin. The results of the classification can then be transmitted for use elsewhere, e.g., at a command center. In such a way, system 150 can be used to facilitate security of a location by being able to allow for discrimination between human footsteps and those of quadrupeds, e.g., horses, dogs. Such seismic-based discrimination can provide for discrimination between signals produced by multiple people and/or multiple animals (or other sources of seismic/vibration signals).

Embodiments of system 150 can be implemented as an inexpensive, lightweight, and robust device for area monitoring, alone or in combination with other similar or different sensors.

As described previously for method 100, embodiments of the present disclosure can employ suitable statistical classifiers to approximate the true probability density function for a multimodal random variable, e.g., as represented by collected seismic data.

Exemplary embodiments of the present disclosure can utilize the Gaussian Mixture Model (GMM) as a suitable classifier. For a multimodal random variable, the values of which are generated by one of several independent sources, a finite mixture model can be used to approximate the true probability density function. Moreover, a GMM is a good candidate as a classifier when there exists no prior knowledge of a probability density function. Therefore, estimating the distribution with a GMM not only can provide a chance to have a general model but also can help to understand the phenomena for a better use of the information of the distribution.

A non-singular multivariate normal distribution of a D dimensional random variable X [symbol] x can be defined as:

$$X \sim N ( x : μ \sum ) = x : μ , \\ Σ = \frac{1}{{( 2 π )}^{D / 2} {\vert Σ \vert}^{1 / 2}} exp [ - \frac{1}{2} {( x - μ )}^{T} {Σ}^{- 1} ( x - μ ) ] \qquad ( EQ . 1 )$$

where μ is the mean vector and Σ the covariance matrix of the normally distributed random variable X.

The GMM can be defined as a weighted sum of Gaussians function:

$$p ( x : θ ) = {\sum }_{c = 1}^{c} {α}_{c} N ( x ; {μ}_{c} , {Σ}_{C} ) \qquad ( EQ . 2 )$$

where α_{c} is the weight of c^{th} mixture and θ is defined as following,

θ={α₁, μ₁, . . . , α_{C}, μ_{C}, Σ_{C}} (EQ. 3)

To estimate, or train, the model parameter θ, a suitable algorithm can be used. In exemplary embodiments, the Figueiredo-Jain (FJ) algorithm can be used, which automatically chooses the optimum number of mixtures during the training. The objective function of the Figueiredo-Jain (FJ) algorithm utilizes the minimum message length criterion (i.e., the FJ algorithm minimizes the objective function) for finding optimum number of mixtures as defined in the EQ. 4 so that it can select best model directly from data rather than hierarchy of model-class:

$$Λ ( Θ , X ) = \frac{V}{2} {\sum }_{c : {α}_{c} > 0}^{ } ln ( \frac{N {α}_{c}}{12} ) + \frac{{C}_{nz}}{2} ln ( \frac{N}{12} ) + \frac{{C}_{nz} ( V + 1 )}{2} - ln L ( X , θ ) \qquad ( EQ . 4 )$$

where N is the number of training points, V is the number of free parameters specifying a component, and C_{nz} is the number of components with nonzero weight in the mixture (α_{C}>0). The last term In L(X.θ) is the log-likelihood of the training data given the distribution parameters θ.

### Exemplary Embodiments

### Experiment and Results

Exemplary embodiments of a system and method were implanted and tested. The data recording included acquisition of seismic data of a horse ridden under different conditions. A horse was chosen for quadruped class because the gait can be easily controlled by a rider and also data can be easily acquired with a rider's control. In addition, the signal itself is clearer than that of a dog due to the high energy transferred from its weight. From a horse ranch of Yucca Valley, Calif., a nine-year-old Hawaiian mustang was recorded using a geophone, a low-cost seismic sensor and developed hardware unit, at an arena and a hill in the early morning.

First, recordings were made as the horse walked and ran around the arena with different gaits for 20 minutes keeping a distance of maximum 100 feet from the sensor, e.g., in order of speed: a walk, a 4-beat gait; a trot, a 2-beat gait; and, a canter, a 3-beat gait. The recorded data also included a different type of walk, called a collective walk or working walk and the transition gait between each gait, which is not one of the previously-described natural gaits. The canter gaits appeared only in short periods mixed with the walking gait and mostly slow canter which was slower than trot. Second, at the hill, the data of gallop, which is the fastest 4-beat gait, and the other natural gaits were recorded for another 20 minutes of walking and running around the hill. The distance from the sensor was from 20 feet to 200 feet.

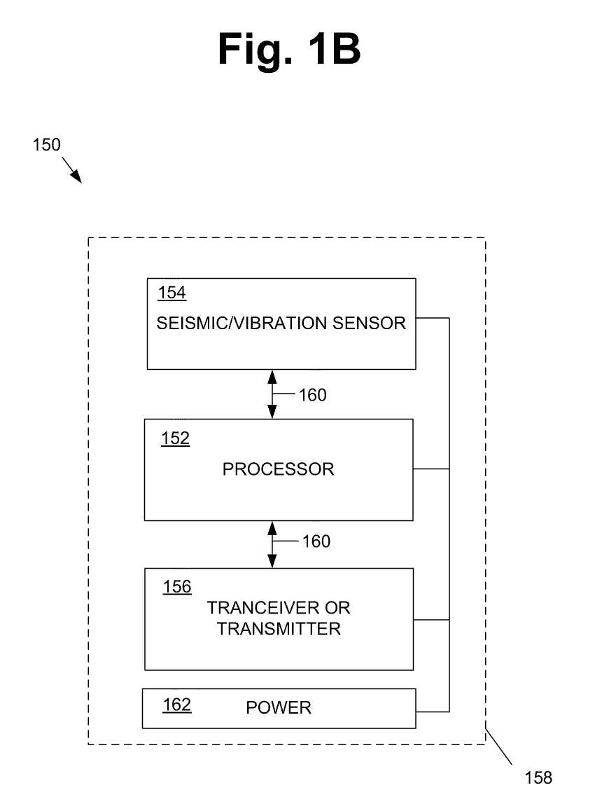

FIG. 2 includes FIGS. 2A-2B, which depict feature vectors for horse and human classes. Each plot represents an independent Gaussian mixture. X-axis is the feature number (1^{st}˜12^{th}: cadence pattern, 13^{th}: gait frequency) and y-axis is normalized amplitude for the 1^{st}˜12^{th} features and frequency for the 13^{th} feature. 6 Gaussian mixtures from a to f for the horse, 4 Gaussian mixtures from g to j for the human were built from the training data set. The bright lines for the 1^{st}˜12^{th} features and the circles for the 13^{th} feature are the mean value of each feature and the shading represents its distribution.

For human footsteps, the data of a single person running and people—group of five—walking in a group were collected at a sandy terrain near the Joshua Tree national park, CA again using the geophone sensor. Each of four different people ran along a straight path of 200 feet and data was recorded for over five roundtrips with speed varying from the fast running speed possible down to fast walking. For the data of people walking in a group, five people walked naturally along the same path in a group for five roundtrips. Then, the same five individuals were recorded walking at the same rate of speed and in sequence, keeping six feet from person to person, for another five roundtrips. Also, they were recorded walking randomly around the sensor for three minutes. The sensor was located five feet away from the middle of the path.

After preprocessing of the data, only human and quadruped's footsteps were detected from the input signal and the other classes were rejected. The rejected data includes background i.e. no event, any event with no gait frequency in the specified frequency band, and transition in speed and gait pattern. The preprocessing includes filtering at 10˜100 Hz and applying a threshold to the auto-correlation function at a window corresponding to 0.5 Hz˜7 Hz gait frequency. Features, e.g., as described for method 100 of FIG. 1A, were extracted from pre-processed data and GMMs were setup to model the features.

As a result of EQ. 4 (above), six Gaussian mixtures for the horse, and four Gaussian mixtures for the human classes were formed during a training process. The mean value and the distribution of each mixture are presented in the FIG. 2, which includes FIGS. 2A-2B.

In FIG. 2A, plots 2a to 2f present the statistics of horse's cadence pattern trained by mixtures. The mixture shown in a is the most likely pattern in the data set for detecting horse and the others (2b to 2f) are presented in the order of their generating likelihood. The mixture shown in plot 2a represents also “walk” which is a 4-beat gait. The mixtures depicted in 2e and 2f are representatives of the other types of the “walk” gait (all of the “walk” gaits show four peaks on their temporal patterns). The mixture e includes the pattern of slow canter which is slow 3-beat gait and in general the feature number 1, 7, and 10 represent the peaks of 3 beats. The mixture 2b represents the gallop which is the fastest 4 beat. In Gallop, the peaks were not observed due to relatively higher variation of the location of the peaks in time and shorter duration of their time period. The mixture 2c and 2d are built for trot which is a fast 2-beat gait. Similarity between two time domain peaks has doubled the gait frequency in the mixture 2d.

In FIG. 2B, plots 2g to 2j show the mixtures of human cadence pattern. The mixture in 2g is the most likely pattern for a human, which is built from a single person's footsteps including running and walking. Although human gait is 2-beat, most human footsteps have similarity between two 2-beats footsteps so that the gait frequency is measured doubled as in the mixture 2g. The mixture 2h and 2i represents multiple the walk of multiple people. Randomness of the location of peaks in time made the feature space flat and the personal variance of the strength of footstep provides the difference between the 1st feature and the other.

To evaluate the performance of the trained recognizers, a self-validation test was performed on the data used for training. During the test, the average of posteriori probabilities of each class on ten consecutive window frames was calculated (an assumption was made that there is/were no abrupt changes within the class). Average posteriori can be used to enhance the low-SNR observations results and reduce false positives.

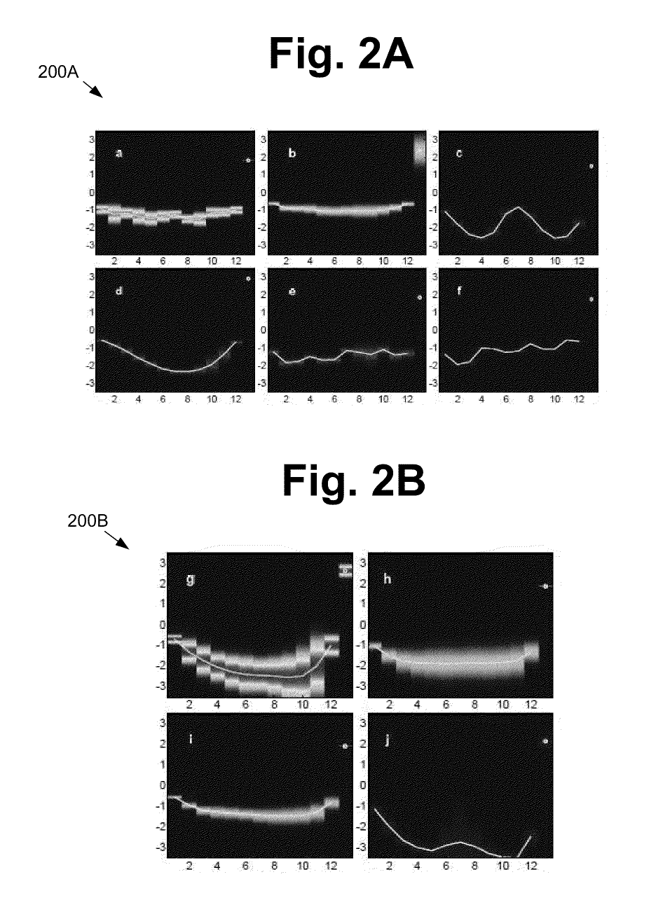

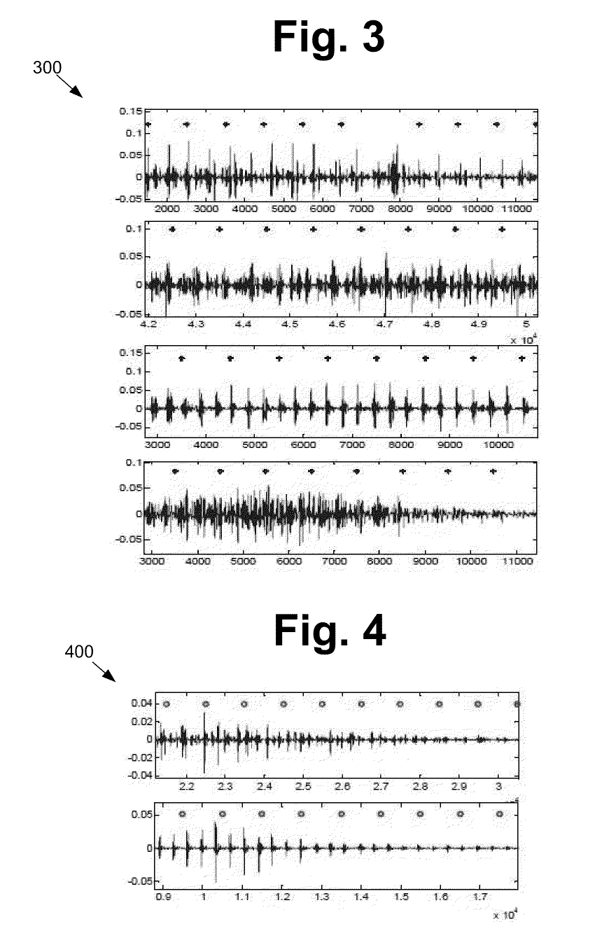

Sample test signals and their results are plotted in the FIGS. 3 and 4, described below. The classification results of the experiments are summarized in Table I.

FIG. 3 depicts a collection 300 of four plots of seismic data from a horse's footsteps and their recognition by an embodiment of the present disclosure. From top to bottom, each plot represents the temporal signal from walk, canter, trot, and gallop, respectively. The bottom axis (X-axis) is sample time in 1/1000 s (milliseconds). The crosses on top of the signal meaning recognized as horse's footstep.

FIG. 4 depicts a collection 400 of two plots of seismic data from human footsteps and their recognition by an embodiment of the present disclosure. The top plot represents the temporal signal from multiple people walking, and the bottom one from multiple people running. The bottom axis (X-axis) is sample time in 10 s. The circles on top of the signal indicates that the implemented embodiment recognized the signal as a human footstep.

For the data set of each class, the number of frames with wrong recognition was counted and its percentage is presented in Table 1. Testing was also conducted separately to ascertain whether discrimination could be discerned between multiple people (e.g., five persons) walking, running, and the footsteps of a horse. The implemented system/method was also tested with additional human walking data (data of a single person walking as recorded a year ago at the same location), which was not utilized for the initial training of the system.

TABLE I
FALSE RECOGNITION RATE FOR HUMAN AND HORSE

| | |
|---|---|
| False recognition (%) | Total frames |

| Test set | Human | Horse | Human | Horse |
|---|---|---|---|---|
| People walk | 1.98 | | 553 | |
| Human run | 5.19 | | 617 | |
| Horse | | 1.86 | | 1561 |
| Human walk | 1.46 | | 3222 | |
| (single person) | | | | |

As indicated in Table 1, a higher false recognition rate on seismic signals of a human running arises from the similarity to the trot gait of the horse. At the specific gait frequency, a human's cadence pattern and a horse's are very similar as can be seen in FIGS. 3 and 4, also in the plots 2.d and 2.g. For the embodiment shown, overall performance was over 95% correct recognition, as shown in the Table 1. Although not shown, a dog's gait was also recognized as quadruped without any additional training suggesting that the model trained with horse can be an appropriate representative for quadruped.

Accordingly, embodiments of the present disclosure can provide methods and/or system for cadence analysis of seismic data from vibration sensors. The fundamental gait frequency and temporal pattern of gait can be used as features for a statistical classifier, for example, a GMM. As a result, the temporal patterns of gait can be recognized as belonging to a particular class of seismic data.

The components, steps, features, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, benefits and advantages. These also include embodiments in which the components and/or steps are arranged and/or ordered differently.

For example, while statistical classifiers, or expectation maximizers, have been described herein as Gaussian Mixture Models, others may be used within the scope of the present disclosure. Suitable alternative statistical classifiers can include, but are not limited to, linear classifiers, quadratic classifiers, k-nearest neighbor, Decision trees, random forests, neural networks, Bayesian networks, and/or Hidden Markov models.

For further example, while seismic/vibrations sensors have been described herein as being or including geophones, other suitable sensors may be used within the scope of the present disclosure. Other suitable sensors can include, but are not limited to, acoustic sensors, e.g., microphones. In addition, the scope of the present disclosure is not limited by the type of underlying sensing technology, e.g., magnetic based, capacitive based as used in MEMS devices, etc.

Moreover, cadence analysis according to the present disclosure can be used to detect other classes of security breaches, e.g., seismic signals generated by small unmanned, and heavy track vehicles)

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications which have been cited in this disclosure are hereby incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to any of the corresponding structures, materials, or acts or to their equivalents.

Nothing that has been stated or illustrated is intended or should be interpreted to cause a dedication of any component, step, feature, benefit, advantage, or equivalent to the public, regardless of whether it is recited in the claims.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

What is claimed is:

1. A method of seismic discrimination for detecting human footsteps, the method comprising:
with a computer system, determining a gait period from a temporal window of seismic data;
with the computer system, partitioning the temporal window into k number of smaller sub-windows, each having a length equal to the gait period;
with the computer system, averaging the signals within the sub-windows;
with the computer system, determining a shift-invariant temporal gait pattern from the averaged signals of the sub-windows;
with the computer system, applying a number of weighting functions to the temporal gait pattern and producing a like number of features of the temporal gait pattern;
with the computer system, modeling the features with a statistical classifier; and
with the computer system, recognizing the seismic data as belonging to a particular class of data.

2. The method of claim 1, wherein modeling the features with a statistical classifier comprises using a Gaussian Mixture Model (GMM).

3. The method of claim 1, wherein determining the gait period comprises using the auto-correlation function.

4. The method of claim 1, wherein determining the shift-invariant temporal gait pattern comprises circular-shifting the temporal gait pattern.

5. The method of claim 1, wherein applying a number of weighting functions to the temporal gait pattern comprises applying twelve weighting functions.

6. The method of claim 5, wherein the weighting functions are triangular.

7. The method of claim 2, wherein using a Gaussian Mixture Model comprises training a model parameter.

8. The method of claim 7, wherein training the model parameter comprises using the Figueiredo-Jain algorithm.

9. The method of claim 8, further comprising, with the computer system, recognizing additional seismic data as belonging to a particular class of data.

10. The method of claim 1, wherein the particular class of data comprises seismic data corresponding to human footsteps.

11. The method of claim 1, wherein the particular class of data comprises seismic data corresponding to quadruped footsteps.

12. The method of claim 1, wherein the particular class of data comprises seismic data corresponding to vehicles.

13. The method of claim 12, wherein the vehicles comprise heavy track vehicles.

14. The method of claim 1, further comprising using gait frequency for recognition of seismic data.

15. The method of claim 1, further comprising moving the temporal window across the seismic data.

16. The method of claim 15, wherein moving the temporal window includes moving the temporal window across the seismic data with a desired degree of overlap.

17. The method of claim 16, wherein the window is three seconds wide and the overlap is about two seconds.

18. The method of claim 1, further comprising enhancing signal-to-noise ratio of the seismic data by passing the data through a band-pass filter.

19. The method of claim 1, further comprising using a Hilbert transform and low-pass filter to extract an envelope of a seismic signal.

20. The method of claim 3, further comprising applying a threshold to the auto-correlation function.

21. The method of claim 20, wherein the threshold is at a window corresponding to about 0.5 Hz to about 7 Hz.

22. A system for discrimination of seismic data, the system comprising:
a vibration sensor system configured and arranged to detect vibrations;
a processor system configured and arranged to (i) receive data from the vibration sensor, (ii) recognize the seismic data as belonging to a particular class of seismic data, and (iii) produce an output signal corresponding to the recognized particular class of seismic data.

23. The system of claim 22, wherein the processor system is further configured and arranged to: (iii) determine a gait period from a temporal window of the seismic data, (iv) partition the temporal window into k number of smaller sub-windows, each having a length equal to the gait period, (v) average the signals within the sub-windows, (vi) determine a shift-invariant temporal gait pattern from the averaged signals of the sub-windows, (vii) apply a number of weighting functions to the temporal gait pattern and produce a like number of features of the temporal gait pattern, and (viii) model the features with a statistical classifier.

24. The system of claim 22, further comprising a wireless transmitter from transmitting the output signal corresponding to the recognized class of seismic data.

25. The system of claim 22, wherein the vibration sensor system comprises one or more geophones.

26. The system of claim 22, wherein the particular class of data comprises seismic data corresponding to human footsteps.

27. The system of claim 22, wherein the particular class of data comprises seismic data corresponding to quadruped footsteps.

28. The system of claim 22, wherein the particular class of data comprises seismic data corresponding to vehicles.

29. The system of claim 22, wherein the vehicles comprise heavy track vehicles.

30. The system of claim 22, wherein the processor system is further configured and arranged to use gait frequency for recognition of seismic data.
